(19) United States
(12) Patent Application Publication
(10) Pub. No.: US 2026/0219442 A1
(43) Pub. Date: Jul. 30, 2026

(54) OPTICAL FIBER WITH LONGITUDINALLY DEPENDENT ZERO-DISPERSION WAVELENGTH AND METHOD OF MAKING SAME

(71) Applicant: CORNING INCORPORATED, CORNING, NY (US)

(72) Inventors: Adrian Alejando Juarez Marroquin, Wellsboro, PA (US); Pushkar Tandon, Painted Post, NY (US)

(21) Appl. No.: 19/445,769

(22) Filed: Jan. 12, 2026

Related U.S. Application Data
(60) Provisional application No. 63/749,912, filed on Jan. 27, 2025.

(51) Int. Cl. G02B 6/036; B29D 11/00; G02B 6/02

(52) U.S. Cl. CPC G02B 6/0365; B29D 11/0074; G02B 6/02009

(57) ABSTRACT

An optical fiber including a core radius (r_{c}), an inner cladding radius (r_{ic}), a trench cladding radius (r_{tc}), an outer cladding radius (r_{oc}), a core composition, an inner cladding composition, a trench cladding composition, and an outer cladding composition that are all substantially constant as a function of position along the length of the optical fiber but with a core refractive index, a inner cladding refractive index, a trench cladding refractive index, and an outer cladding refractive index that all vary as a function of position along the length of the optical fiber so that the optical fiber exhibits a zero-dispersion wavelength that repeatedly and sequentially rises and falls along the length of the optical fiber about an average zero-dispersion wavelength within a range of from 1300 nm to 1324 nm and with a peak-to-valley variation greater than or equal to 5 nm.

This application claims the benefit of priority to U.S. Provisional Patent Application Ser. No. 63/749,912 filed on Jan. 27, 2025, the content of which is relied upon and incorporated herein by reference in its entirety.

### TECHNICAL FIELD

The present invention generally relates to an optical fiber and method of making the same and, more particularly, to an optical fiber that exhibits a zero-dispersion wavelength that increases and decreases repeatedly and sequentially along a length of the optical fiber to modulate four-wave mixing.

### BACKGROUND

Optical fibers are utilized to transmit data. More particularly, a source (e.g., a laser) generates pulses of electromagnetic radiation of a desired wavelength representing the data into the optical fiber. The optical fiber transmits the pulses of electromagnetic radiation via total internal reflection. Where the optical fiber terminates, a detector detects the pulses of electromagnetic radiation and converts the pulses back into data.

There is a continuous push to increase the amount of data that an optical fiber can transmit. Through the technique of wavelength division multiplexing, multiple sources can generate pulses of electromagnetic radiation, each at a different wavelength, and a single optical fiber can transmit simultaneously the pulses from the multiple sources. Pulses from hundreds or more sources may be transmitted through the optical fiber, drastically increasing the bandwidth of the optical fiber.

It is further desirable to transmit optical signals through optical fibers over large distances. Because various loss mechanisms cause the optical signals to attenuate over long transmission distances, high-power sources are used to introduce the optical signals into the optical fiber. However, Kerr-induced nonlinear interactions can arise more readily when high-power sources are utilized. Kerr-induced nonlinear interactions manifest as self-phase modulation (SPM), cross-phase modulation (XPM), and four-wave mixing (FWM). Four-wave mixing (FWM), in particular, is a non-linear effect that can occur when pulses of electromagnetic radiation of different wavelengths from different sources propagate simultaneously through the optical fiber. Through FWM, the multiple wavelengths of electromagnetic radiation can interact with each other to generate one or more new wavelengths of electromagnetic radiation. The newly formed wavelengths can interfere with the originally transmitted wavelengths, reducing the signal-to-noise ratio. That is problematic because the reduced signal-to-noise ratio, and overall degradation of the intended wavelengths, increase the bit error rate of the total transmission.

To address the FWM problem, and Kerr-induced nonlinear interactions generally, dispersion-shifted fibers have been considered. With dispersion-shifted fibers, the zero-dispersion wavelength (ZDW, the shortest wavelength where no chromatic dispersion of the transmitted wavelength occurs) is pushed to longer wavelengths (e.g., 1550 nm). Non-linear effects tend to lessen the as operating wavelength (and thus ZDW) is increased. However, standards promulgated by the Institute of Electrical and Electronics Engineers (IEEE) typically require the zero-dispersion wavelength of the optical fiber to be within a range of from 1300 nm to 1324 nm (e.g., within the O-band).

At least in part because of standards-based limitations, dispersion-managed fibers have additionally been considered to address Kerr-induced nonlinear interactions, including FWM. With a dispersion-managed fiber, at least a portion of the length of the optical fiber exhibits a dispersion slope that is opposite of the dispersion slope of the single mode fiber portion. The length of the portion that is dispersion managed is chosen to compensate for the dispersion that accumulates within the single mode fiber portion.

Optical fibers with managed dispersion characteristics have heretofore been formed in a variety of ways. For example, an optical fiber preform with longitudinal composition variation to result in the optical fiber drawn therefrom having a variable refractive index profile as a function of length has been utilized. Other attempts included varying the core and/or cladding radius while keeping the refractive index profile the same, such as through selective heating and cooling of the optical fiber. However, such methods can be suboptimally expensive and cumbersome, and can result in sharp transitions in the zero-dispersion wavelength along the length of the optical fiber, which can degrade transmission performance.

### SUMMARY

The present disclosure addresses issues arising from Kerr-induced nonlinear interactions, including FWM, with an optical fiber that avoids the drawbacks of prior attempts. More particularly, the optical fiber has a radial composition profile that is consistent along the length of the optical fiber. The compositional profiles of the various regions of the optical fiber (e.g., core region, inner cladding region, and so on) are consistent along the length of the optical fiber. Rather, only the radial refractive index profile changes as a function of position along the length of the optical fiber. The variable refractive index profile in turn results in the optical fiber exhibiting a zero-dispersion wavelength that rises and falls sequentially and repeatedly along the length of the optical fiber. The variable refractive index profile along the length is achieved neither by changing heat flux during draw of the optical fiber from the optical fiber preform nor by inducing compositional changes but by modulating the tension applied during the draw. The tension rises and falls sequentially and repeatedly as a function of time during the draw.

According to a first aspect of the present disclosure, an optical fiber comprises: (a) a longitudinal axis; (b) a length extending along the longitudinal axis; (c) a core region centered about the longitudinal axis to a core radius (r_{c}) from the longitudinal axis, the core region comprising a core composition and exhibiting a core refractive index; (d) an inner cladding region disposed radially outward of the core region from the core radius (r_{c}) to an inner cladding radius (r_{ic}) from the longitudinal axis, the inner cladding region comprising an inner cladding composition and exhibiting an inner cladding refractive index that is less than the core refractive index; (e) a trench cladding region disposed radially outward of the inner cladding region from the inner cladding radius (r_{ic}) to a trench cladding radius (r_{tc}), the trench cladding region comprising a trench cladding composition and exhibiting a trench cladding refractive index that is less than the inner cladding refractive index; and (f) an outer cladding region disposed radially outward of the trench cladding region from the trench cladding radius (r_{tc}) to an outer cladding radius (r_{oc}), the outer cladding region comprising an outer cladding composition and exhibiting an outer cladding refractive index that is greater than the trench cladding refractive index, wherein (i) the core radius (r_{c}), the inner cladding radius (r_{ic}), the trench cladding radius (r_{tc}), and the outer cladding radius (r_{oc}) are all substantially constant as a function of position along the length of the optical fiber, (ii) the core composition, the inner cladding composition, the trench cladding composition, and the outer cladding composition are all substantially constant as a function of position along the length of the optical fiber, (iii) the core refractive index, the inner cladding refractive index, the trench cladding refractive index, and the outer cladding refractive index all vary as a function of position along the length of the optical fiber, and (iv) the optical fiber has a non-uniform distribution of zero-dispersion wavelength along the length of the optical fiber, with the zero-dispersion wavelength repeatedly rising and falling in sequence along the length of the optical fiber, and comprising an average zero-dispersion wavelength within a range of from 1300 nm to 1324 nm and a peak-to-valley variation greater than or equal to 5 nm.

According to a second aspect of the present disclosure, the optical fiber of the first aspect is presented, wherein (i) the trench cladding region further comprises a trench volume that varies as a function of the position along the length of the optical fiber, and (ii) the trench volume varies entirely within a range of from 20%-μm² to 65%-μm².

According to a third aspect of the present disclosure, the optical fiber of any one of the first through second aspects is presented, wherein the non-uniform distribution of zero-dispersion wavelength comprises a distribution of zero-dispersion wavelength that varies periodically along the length of the optical fiber, the periodically varying distribution comprising a modulation amplitude and a modulation period.

According to a fourth aspect of the present disclosure, the optical fiber of the third aspect is presented, wherein the modulation amplitude of the zero-dispersion wavelength is within a range of from 5.0 nm to 18.0 nm.

According to a fifth aspect of the present disclosure, the optical fiber of any one of the third through fourth aspects is presented, wherein the modulation period of the zero-dispersion wavelength is within a range of from 1.0 km to 2.5 km.

According to a sixth aspect of the present disclosure, the optical fiber of any one of the third through fifth aspects is presented, wherein the periodically varying distribution is sinusoidal.

According to a seventh aspect of the present disclosure, the optical fiber of any one of the first through sixth aspects is presented, wherein the optical fiber exhibits a bit error rate (BER) of less than 5×10⁻⁶/km for a launch power within a range of from −4 to 2 dBm when transmitting an optical signal at a wavelength within a range of from 1260 nm and 1360 nm and at a transmission rate of greater than or equal to 1.6 Tb/s.

According to an eighth aspect of the present disclosure, the optical fiber of the seventh aspect is presented, wherein the BER that the optical fiber exhibits is less than 5×10⁻⁷/km for a launch power within a range of from −4 to 2 dBm when transmitting an optical signal at a wavelength within a range of from 1260 nm and 1360 nm and at a transmission rate of greater than or equal to 1.6 Tb/s.

According to a ninth aspect of the present disclosure, the optical fiber of the eighth aspect is presented, wherein the BER that the optical fiber exhibits is less than less than 5×10⁻⁸/km for a launch power within a range of from −4 to 2 dBm when transmitting an optical signal at a wavelength within a range of from 1260 nm and 1360 nm and at a transmission rate of greater than or equal to 1.6 Tb/s.

According to a tenth aspect of the present disclosure, the optical fiber of any one of the first through ninth aspects is presented, wherein the optical fiber exhibits a cable cutoff that repeatedly increases and decreases in sequence along the length of the optical fiber.

According to an eleventh aspect of the present disclosure, the optical fiber of the tenth aspect is presented, wherein the cable cutoff that the optical fiber exhibits does not exceed 1260 nm along the length of the optical fiber.

According to a twelfth aspect of the present disclosure, the optical fiber of the tenth aspect is presented, wherein the cable cutoff that the optical fiber exhibits varies entirely within a range of from 1150 nm to 1250 nm along the length of the optical fiber.

According to a thirteenth aspect of the present disclosure, the optical fiber of any one of the first through twelfth aspects is presented, wherein the optical fiber exhibits a mode field diameter that varies as a function of the position along the length of the optical fiber.

According to a fourteenth aspect of the present disclosure, the optical fiber of the thirteenth aspect is presented, wherein the mode field diameter that the optical fiber exhibits varies entirely within a range of from 8.2 μm to 9.5 μm along the length of the optical fiber.

According to a fifteenth aspect of the present disclosure, the optical fiber of any one of the first through fourteenth aspects is presented, wherein the optical fiber exhibits a 15 mm diameter bend loss at 1550 nm of less than or equal to 0.5 dB/turn.

According to a sixteenth aspect of the present disclosure, a method of making optical fiber comprises: (1) a drawing step comprising drawing a length of optical fiber under tension from an optical fiber preform; and (2) a tension varying step comprising repeatedly and sequentially increasing and decreasing the tension under which the optical fiber is drawn in a predetermined manner as a function of time and within a predetermined tension range, wherein (a) while the drawing step and the tension varying step are occurring, the optical fiber is not subjected to localized heating or cooling that varies in a predetermined manner as a function of time, (b) the predetermined tension range is from 20 grams to 400 grams, and (c) the optical fiber preform comprises: (i) a preform longitudinal axis, (ii) a preform length extending along the preform longitudinal axis, (iii) a preform core region centered about the preform longitudinal axis and extending radially therefrom to a preform core radius, (iv) a preform inner cladding region disposed radially outward of the preform core region from the preform core radius to a preform inner cladding radius from the preform inner cladding longitudinal axis, (v) a preform trench cladding region disposed radially outward of the preform inner cladding region from the preform inner cladding radius to a preform trench cladding radius, (vi) a preform outer cladding region disposed radially outward of the preform trench cladding region from the preform trench cladding radius to a preform outer cladding radius, and (vii) the preform core radius, the preform inner cladding radius, the preform trench cladding radius, and the preform outer cladding radius are all substantially constant as a function of position along the preform length.

According to a seventeenth aspect of the present disclosure, the method of the sixteenth aspect is presented, wherein during the tension varying step, the tension as a function of time has a substantially fixed amplitude.

According to an eighteenth aspect of the present disclosure, the method of any one of the sixteenth through seventeenth aspects is presented, wherein during the tension varying step, the tension as a function of time has a substantially fixed period.

According to a nineteenth aspect of the present disclosure, the method of the eighteenth aspect is presented, wherein the substantially fixed period corresponds to the length of the optical fiber within a range of from 1.5 km to 2.5 km.

According to a twentieth aspect of the present disclosure, the method of any one of the sixteenth through nineteenth aspects is presented, wherein during the tension varying step, the tension as a function of time has a substantially sinusoidal profile.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiments, and together with the description, serve to explain principles and operation of the various embodiments.

### BRIEF DESCRIPTION OF THE DRAWINGS

In the Drawings:

FIG. 1 is a perspective view of an optical fiber of the present disclosure;

FIG. 2 is an elevational view of a cross-section of the optical fiber taken through line II-II of FIG. 1, illustrating a core region disposed around a longitudinal axis, an inner cladding region disposed around the core region, a trench cladding region disposed around the inner cladding region, and an outer cladding region disposed around the trench cladding region;

FIG. 3 is schematic diagram plotting relative refractive index as a function of radius from the longitudinal axis, illustrating the core region exhibiting a core refractive index, the inner cladding region exhibiting an inner cladding refractive index that is less than the core refractive index, the trench cladding region exhibiting a trench cladding refractive index that is less than the inner cladding refractive index, and the outer cladding region exhibiting an outer cladding refractive index that is greater than the trench cladding refractive index;

FIG. 4 is a schematic diagram of a method of making the optical fiber, illustrating (i) a drawing step during which the optical fiber is drawn from an optical fiber preform and (ii) a tension varying step during which the tension applied to the optical fiber during the drawing step is repeatedly and sequentially increased and decreased as a function of time so that the relative refractive indices of the optical fiber change repeatedly and sequentially as a function of position along the length of the optical fiber, which causes the zero-dispersion wavelength that the optical fiber exhibits to repeatedly and sequentially rise and fall as a function of position along the length of the optical fiber in order to modulate four-wave mixing;

FIG. 5 is another schematic diagram of the method, illustrating a drawings system and a fiber take-up system that can be utilized to perform the drawing step and the tension varying step, respectively;

FIG. 6 is a cross-sectional view of the optical fiber preform;

FIG. 7, pertaining to Example 1, is a graph that plots the zero-dispersion wavelength that a computer modeled optical fiber exhibits as a function of position along the length of the optical fiber, illustrating that the amplitude of the rise and fall of the zero-dispersion wavelength can be engineered while maintaining a period that is constant;

FIG. 8, pertaining to Example 1, is a graph that plots the zero-dispersion wavelength that a computer modeled optical fiber exhibits as a function of position along the length of the optical fiber, illustrating that the period of the rise and fall of the zero-dispersion wavelength can be engineered while maintaining an amplitude that is constant;

FIG. 9, pertaining to Example 2, is a graph that plots bit error rate (BER) as a function of launch power, as determined via computer modeling, for optical fibers where the rise and fall of the zero-dispersion wavelength have different relative amplitudes but the same period, illustrating that the relative amplitude of magnitude 2 exhibited the lowest BER;

FIG. 10, pertaining to Example 3, is a graph that plots bit error rate (BER) as a function of launch power, as determined via computer modeling, for optical fibers where the rise and fall of the zero-dispersion wavelength have different relative periods but the same amplitude, illustrating that the period of 2.0 km exhibited the lowest BER;

FIG. 11, pertaining to Example 4, is a graph that plots axial stress as a function of radial location from the longitudinal axis of computer modeled optical fibers and as a function of the tension applied during draw of each of the optical fibers, illustrating that axial stress for any of the various regions of the optical fiber changes as a function of changing tension; and

FIG. 12, pertaining to Example 4, is a graph that plots relative refractive index as a function of radial location from the longitudinal axis of computer modeled optical fibers and as a function of the tension applied during draw of each of the optical fibers, illustrating that relative refractive index for any of the various regions of the optical fiber changes as a function of changing tension.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

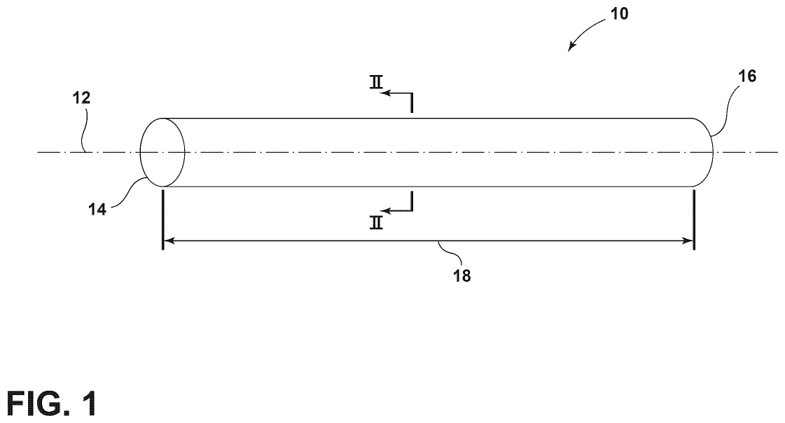

Referring to FIG. 1, an optical fiber 10 includes a longitudinal axis 12, a first end 14, a second end 16, and a length 18. The length 18 of the optical fiber 10 is from the first end 14 to the second end 16. The longitudinal axis 12 extends from the first end 14 to the second end 16 along the length 18 of the optical fiber 10. The length 18 can be any value, such as within a range of from 1 km to 10000 km. The length 18 can be less than 1 km and has no minimum value. The length 18 can be greater than 10000 km and has no maximum value. The length 18 can be 1 km, 5 km, 10 km, 50 km, 100 km, 500 km, 1000 km, or within any range bound by any two of those values.

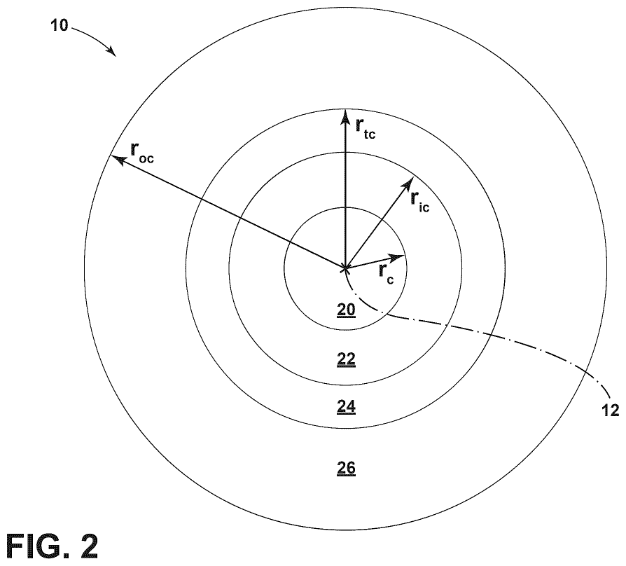

Referring additionally to FIG. 2, the optical fiber 10 further includes a core region 20, an inner cladding region 22, a trench cladding region 24, and an outer cladding region 26. The core region 20 is centered about the longitudinal axis 12 (e.g., the longitudinal axis 12 extends through the core). The core region 20 extends radially from the longitudinal axis 12 to a core radius (r_{c}) from the longitudinal axis 12. The value of the core radius (r_{c}) is not particularly limited. In embodiments, the core radius (r_{c}) is 1.0 μm, 1.2 μm, 1.4 μm, 1.6 μm, 1.8 μm, 2.0 μm, 2.2 μm, 2.4 μm, 2.6 μm, 2.8 μm, 3.0 μm, 3.2 μm, 3.4 μm, 3.6 μm, 3.8 μm, 4.0 μm, 4.2 μm, 4.4 μm, 4.6 μm, 4.8 μm, 5.0 μm, or within any range bound by any two of those values (e.g., from 1.0 μm to 5.0 μm, from 3.0 μm to 5.0 μm, from 3.4 μm to 4.6 μm, and so on). The core radius (r_{c}) can be less than 1.0 μm or greater than 5.0 μm. The core region 20 has a core composition and exhibits a core refractive index, both of which will be further discussed below.

The inner cladding region 22 is disposed radially outward of the core region 20 relative to the longitudinal axis 12. The inner cladding region 22 extends from the core radius (r_{c}) to an inner cladding radius (r_{ic}) from the longitudinal axis 12. The value of the inner cladding radius (r_{ic}) is not particularly limited. In embodiments, the inner cladding radius (r_{ic}) is 5.2 μm, 5.4 μm, 5.6 μm, 5.8 μm, 6.0 μm, 6.2 μm, 6.4 μm, 6.6 μm, 6.8 μm, 7.0 μm, 7.2 μm, 7.4 μm, 7.6 μm, 7.8 μm, 8.0 μm, 8.2 μm, 8.4 μm, 8.6 μm, 8.8 μm, 9.0 μm, 9.2 μm, 9.4 μm, 9.6 μm, 9.8 μm, 10.0 μm, 10.2 μm, 10.4 μm, 10.6 μm, 10.8 μm, 11.0 μm, or within any range bound by any two of those values (e.g., from 5.2 μm to 11.0 μm, from 7.0 μm to 9.0 μm, and so on). The inner cladding radius (r_{ic}) can be less than 5.2 μm or greater than 11.0 μm. The inner cladding region 22 has an inner cladding composition and exhibits an inner cladding refractive index, both of which will be further discussed below.

The trench cladding region 24 is disposed radially outward of the inner cladding region 22 relative to the longitudinal axis 12. The trench cladding region 24 extends from the inner cladding radius (r_{ic}) to a trench cladding radius (r_{tc}) from the longitudinal axis 12. The value of the trench cladding radius (r_{tc}) is not particularly limited. In embodiments, the trench cladding radius (r_{tc}) is 10.0 μm, 10.2 μm, 10.4 μm, 10.6 μm, 10.8 μm, 11.0 μm, 11.2 μm, 11.4 μm, 11.6 μm, 11.8 μm, 12.0 μm, 12.2 μm, 12.4 μm, 12.6 μm, 12.8 μm, 13.0 μm, 13.2 μm, 13.4 μm, 13.6 μm, 13.8 μm, 14.0 μm, 14.2 μm, 14.4 μm, 14.6 μm, 14.8 μm, 15.0 μm, 15.2 μm, 15.4 μm, 15.6 μm, 15.8 μm, 16.0 μm, 16.2 μm, 16.4 μm, 16.6 μm, 16.8 μm, 17.0 μm, 17.2 μm, 17.4 μm, 17.6 μm, 17.8 μm, 18.0 μm, 18.2 μm, 18.4 μm, 18.6 μm, 18.8 μm, 19.0 μm, 19.2 μm, 19.4 μm, 19.6 μm, 19.8 μm, 20.0 μm, 20.2 μm, 20.4 μm, 20.6 μm, 20.8 μm, 21.0 μm, or within any range bound by any two of those values (e.g., from 10.0 μm to 21.0 μm, from 12.0 μm to 18.0 μm, and so on). The trench cladding radius (r_{tc}) can be less than 10.0 μm or greater than 21.0 μm. The trench cladding region 24 has a trench cladding composition and exhibits a trench cladding refractive index, both of which will be further discussed below.

The outer cladding region 26 is disposed radially outward of the trench cladding region 24 relative to the longitudinal axis 12. The outer cladding region 26 extends from the trench cladding radius (r_{tc}) to an outer cladding radius (r_{oc}) from the longitudinal axis 12. The value of the outer cladding radius (r_{oc}) is not particularly limited. In embodiments, the outer cladding radius (r_{oc}) is 40.0 μm, 41.0 μm, 42.0 μm, 43.0 μm, 44.0 μm, 45.0 μm, 46.0 μm, 47.0 μm, 48.0 μm, 49.0 μm, 50.0 μm, 51.0 μm, 52.0 μm, 53.0 μm, 54.0 μm, 55.0 μm, 56.0 μm, 57.0 μm, 58.0 μm, 59.0 μm, 60.0 μm, 61.0 μm, 62.0 μm, 63.0 μm, 64.0 μm, 65.0 μm, 66.0 μm, 67.0 μm, 68.0 μm, 69.0 μm, 70.0 μm, or within any range bound by any two of those values (e.g., from 40.0 μm to 70.0 μm, from 60.0 μm to 70.0 μm, and so on). The outer cladding radius (r_{oc}) can be less than 40.0 μm or greater than 70.0 μm. The outer cladding region 26 has an outer cladding composition and exhibits an outer cladding refractive index (n_{oc}), both of which will be further discussed below.

The core radius (r_{c}), the inner cladding radius (r_{ic}), the trench cladding radius (r_{tc}), and the outer cladding radius (r_{oc}) are all substantially constant as a function of position along the length 18 of the optical fiber 10. “Substantially constant” here means that the optical fiber 10 is manufactured with the intent that the radii are constant (e.g., no intentional variations in any of the radii as a function of position) but manufacturing imprecision may result in some variation in radius. The magnitude of the extent of the variation in radius as a function of position along the length 18 of the optical fiber 10, however, is less than 5% of the average radius as a function of position along the length 18 of the optical fiber 10. For example, if the average of a radius as a function of position along the length 18 of the optical fiber 10 is 60 μm, the radius is substantially constant if the radius is between 57 μm and 63 μm along the length 18 of the optical fiber 10. In some embodiments the manufacturing has high precision and the magnitude of the extent of the variation in radius as a function of position along the length 18 of the optical fiber 10 is less than 4%, or less than 3%, or less than 2%, or less than 1% of the average radius as a function of position along the length 18 of the optical fiber 10.

As mentioned, the core region 20 exhibits the core refractive index, the inner cladding region 22 exhibits the inner cladding refractive index, the trench cladding region 24 exhibits the trench cladding refractive index, and the outer cladding region 26 exhibits the outer cladding refractive index. The inner cladding refractive index is less than the core refractive index. In turn, the trench cladding refractive index is less than the inner cladding refractive index. Finally, the outer cladding refractive index is greater than the trench cladding refractive index. These relative refractive indexes are for any given position along the length 18 of the optical fiber 10.

The relative differences between the refractive indices are achieved, at least in part by differences in composition among one or more of the core composition, the inner cladding composition, the trench cladding composition, and the outer cladding composition. In embodiments, the core composition, the inner cladding composition, the trench cladding composition, and the outer cladding composition all comprise primarily silica SiO₂. One or more of the core composition, the inner cladding composition, the trench cladding composition, and the outer cladding composition can further include one or more dopants (e.g., Ge, Cl, P, F, B) of the appropriate concentration relative to other compositions to effectuate the relative differences in the refractive indices. The core composition, the inner cladding composition, the trench cladding composition, and the outer cladding composition are all substantially constant as a function of position along the length 18 of the optical fiber 10. “Substantially constant” here means that the optical fiber 10 is manufactured with the intent that the compositions are constant (e.g., no intentional variations in the concentration of any element of a composition as a function of position) but manufacturing imprecision may result in some variation in composition. The magnitude of the extent of the variation in concentration of each element (Si or dopant) of the composition as a function of position along the length 18 of the optical fiber 10, however, is less than 5% of the average concentration of the element of the composition as a function of position along the length 18 of the optical fiber 10. For example, if the average concentration of an element of the composition as a function of position along the length 18 of the optical fiber 10 is 1.00 wt %, the concentration of the element of the composition is substantially constant if the concentration is between 0.95 wt % and 1.05 wt % along the length 18 of the optical fiber 10. In some embodiments the manufacturing has high precision and the magnitude of the extent of the variation in the concentration of each element of the concentration as a function of position along the length 18 of the optical fiber 10 is less than 4%, or less than 3%, or less than 2%, or less than 1% of the average concentration of the element of the composition as a function of position along the length 18 of the optical fiber 10.

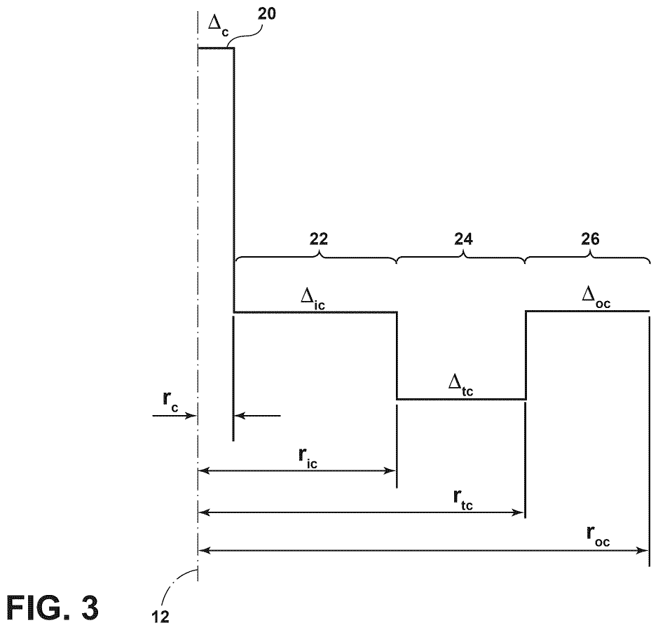

Referring now to FIG. 3, the relative differences between the refractive indices can be quantified in terms of relative refractive index (4%). The “relative refractive index” as used herein is defined as:

$$Δ \% = 100 \frac{{n}^{2} ( r ) - {n}_{o c}^{2}}{2 {n}^{2} ( r )}$$

where n(r) is the refractive index of the optical fiber 10 at the radius r from the longitudinal axis 12 of the optical fiber 10 at a wavelength of 1550 nm, unless otherwise specified, and n_{oc} is the outer cladding refractive index at a wavelength of 1550 nm. When the outer cladding composition is essentially pure silica, n_{oc} is about 1.444 at a wavelength of 1550 nm. As used herein, the relative refractive index percent (also referred herein as the “relative refractive index” for short) is represented by Δ (or “delta”), 4% (or “delta %”), or %, all of which can be used interchangeably, and its values are given in units of percent or %, unless otherwise specified. Relative refractive index is also expressed as Δ(r) or Δ(r) %.

In cases where the refractive index of a region (e.g., the trench cladding region 24) is less than the reference index n_{oc}, the relative index percent is negative and is referred to as having a depressed region or depressed index (also referred to as a “trench”), and the minimum relative refractive index is calculated at the point at which the relative index is most negative unless otherwise specified. In cases where the refractive index of a region (e.g., the core region 20) is greater than the reference index n_{oc}, the relative index percent is positive and the region can be said to be raised or to have a positive index.

The parameter a (also called the “profile parameter” or “alpha parameter”) as used herein relates to the relative refractive index Δ (%) where r is the radius (radial coordinate), and which is defined by:

$$Δ ( r ) = {Δ}_{0} \{ 1 - [ \frac{( r - {r}_{m} )}{{r}_{0} - {r}_{m}} ] α \}$$

where rₘ is the point where Δ(r) is the maximum Δ₀, r₀ is the point at which Δ(r)=0 and r is in the range rᵢₙᵢₜᵢₐₗ to r_{final}, where Δ(r) is defined above, rᵢₙᵢₜᵢₐₗ is the initial point of the α-profile, r_{final} is the final point of the α-profile and α is an exponent that is a real number. For a step index profile, α is greater than 10, and for a gradient-index profile, a less than 5. In FIG. 3, Δ_{c} refers to the relative refractive index of the core region 20, Δ_{ic} refers to the relative refractive index of the inner cladding region 22, Δ_{tc} refers to the relative refractive index of the trench cladding region 24, and Δ_{oc} refers to the relative refractive index of the outer cladding region 26.

The “trench volume” is denoted by V and is defined for the trench cladding region 24 with a relative refractive index Δ_{tc} as a constant Δ_{tc, min}:

$$V = {Δ}_{tc , min} [ {( {r}_{tc} )}^{2} - {( {r}_{i c} )}^{2} ]$$

In an example where the relative refractive index Δ_{tc} varies with radial coordinate (e.g., Δ_{tc}(r)), then the trench volume is given by

$$V = 2 \int {Δ}_{tc} ( r ) r d r$$

with the limits on the integration being from r_{ic} to r_{ic} and the units in “%-μm²”. In some embodiments, the shape of the trench is rectangular, e.g., the index depression in the trench cladding region 24 is fairly uniform as a function of the radial position. In other embodiments, the shape of the trench is triangular, e.g., the index depression in the trench cladding region 24 increases or decreases with the radial position.

While the radii and the compositions of the mentioned regions are substantially constant as a function of position along the length 18 of the optical fiber 10, the trench volume (V) of the trench cladding region 24 varies as a function of position along the length 18 of the optical fiber 10. In embodiments, the trench volume (V) varies entirely within a range of from 20%-μm² to 65%-μm². For example, at any given position along the length 18 of the optical fiber 10, the trench volume V can be 20%-μm², 25%-μm², 30%-μm², 35%-μm², 40%-μm², 45%-μm², 50%-μm², 55%-μm², 60%-μm², 65%-μm², or within any range bound by any two of those values (e.g., from 30%-μm² to 55%-μm², from 40%-μm² to 50%-μm², and so on). By “varies entirely” is meant that the trench volume (V) at each position along the length 18 of the optical fiber 10 is within the ranges set forth herein.

Similarly, the core refractive index, the inner cladding refractive index, the trench cladding refractive index, and the outer cladding refractive index all vary as a function of position along the length 18 of the optical fiber 10, which can be due to the tension modulation induced on the optical fiber during draw as discussed further below. The variability of the refractive indices results in the optical fiber 10 exhibiting a non-uniform distribution of zero-dispersion wavelength along the length 18 of the optical fiber 10. Stated another way, the zero-dispersion wavelength that the optical fiber 10 exhibits varies as a function of position along the length 18 of the optical fiber 10 as well. The zero-dispersion wavelength repeatedly rises and falls in sequence as a function of position along the length 18 of the optical fiber 10. In turn, the variability of the zero-dispersion wavelength that the optical fiber 10 exhibits (the repeated rising and falling) modulates the Kerr-induced nonlinear interactions, including four-wave mixing, occurring within the optical fiber 10. The zero-dispersion wavelength is a wavelength at which the dispersion has a value of zero. “Dispersion” unless otherwise noted, is the sum of the material dispersion, the waveguide dispersion, and the inter-modal dispersion. In the case of single mode optical fibers, the inter-modal dispersion is zero.

In embodiments, the optical fiber 10 exhibits an average zero-dispersion wavelength along the length 18 of the optical fiber 10 that is within a range of from 1300 nm to 1324 nm. For example, the average zero-dispersion wavelength can be 1300 nm, 1301 nm, 1302 nm, 1303 nm, 1304 nm, 1305 nm, 1306 nm, 1307 nm, 1308 nm, 1309 nm, 1310 nm, 1311 nm, 1312 nm, 1313 nm, 1314 nm, 1315 nm, 1316 nm, 1317 nm, 1318 nm, 1319 nm, 1320 nm, 1321 nm, 1322 nm, 1323 nm, 1324 nm, or within any range bound by any two of those values (e.g., from 1305 nm to 1320 nm, from 1306 nm to 1323 nm, and so on). In some instances, the zero-dispersion wavelength that the optical fiber 10 exhibits along an entirety of the length 18 of the optical fiber 10 is within the range of from 1300 nm to 1324 nm.

As mentioned, the zero-dispersion wavelength that the optical fiber 10 exhibits varies along the length 18 of the optical fiber 10. As position along the length 18 of the optical fiber 10 changes, the zero-dispersion wavelength that the optical fiber 10 exhibits repeatedly changes between a local maximum value, a local minimum value, and then a local maximum value, and so on along the length 18. The peak-to-valley variation between the local maximum value and the local minimum value is greater than or equal to 5 nm.

In embodiments, the non-uniform distribution (e.g., the variance along the length 18) of the zero-dispersion wavelength that the optical fiber 10 exhibits includes a distribution of zero-dispersion wavelength that varies periodically along the length 18 of the optical fiber 10. In other words, the variation of the zero-dispersion wavelength as a function of position along the length 18 is periodic. In such instances, the periodically varying distribution includes a modulation amplitude and a modulation period. The modulation amplitude is the difference between the average zero-dispersion wavelength and the local maxima, which may be substantially the same along the length 18. In embodiments, the modulation amplitude is within a range of from 5.0 nm to 18.0 nm. For example, the modulation amplitude can be 5.0 nm, 5.5 nm, 6.0 nm, 6.5 nm, 7.0 nm, 7.5 nm, 8.0 nm, 8.5 nm, 9.0 nm, 9.5 nm, 10.0 nm, 10.5 nm, 11.0 nm, 11.5 nm, 12.0 nm, 12.5 nm, 13.0 nm, 13.5 nm, 14.0 nm, 14.5 nm, 15.0 nm, 15.5 nm, 16.0 nm, 16.5 nm, 17.0 nm, 17.5 nm, 18.0 nm, or within any range bound by any two of those values (e.g., from 11.0 nm to 14.5 nm, from 15.5 nm to 17.5 nm, and so on). In some instances, the modulation amplitude is substantially constant along the length 18 of the optical fiber 10.

The modulation period is the distance along the length 18 between adjacent local maxima. In embodiments, the modulation period is within a range of from 1.0 km to 2.5 km. For example, the modulation period can be 1.0 km, 1.1 km, 1.2 km, 1.3 km, 1.4 km, 1.5 km, 1.6 km, 1.7 km, 1.8 km, 1.9 km, 2.0 km, 2.1 km, 2.2 km, 2.3 km, 2.4 km, 2.5 km, or within any range bound by any two of those values (e.g., from 1.7 km to 2.1 km, from 2.0 km to 2.4 km, and so on). In some instances, the modulation period is substantially constant along the length 18 of the optical fiber 10.

In embodiments, the periodically varying distribution of the zero-dispersion wavelength is sinusoidal. In other embodiments, the periodically varying distribution of the zero-dispersion wavelength is sawtooth. Those are just examples, and the periodically varying distribution can take other forms.

In embodiments, the optical fiber 10 exhibits a bit error rate (BER) of less than 5×10⁻⁶/km for a launch power between-4 and 2 dBm when transmitting an optical signal at a wavelength within a range of from 1260 nm to 1360 nm and at transmission rates of greater than or equal to 1.6 Tb/s. The BER for the optical fiber 10 can be determined using a BER tester, as known in the art. The “launch power” is the signal power of an incident signal launched into the optical fiber 10. In embodiments, the BER that the optical fiber 10 exhibits is less than 5×10⁻⁷/km for a launch power between-4 and 2 dBm when transmitting an optical signal at a wavelength within a range of from 1260 nm to 1360 nm and at transmission rates of greater than or equal to 1.6 Tb/s. In embodiments, the BER that the optical fiber 10 exhibits is less than less than 5×10⁻⁸/km for a launch power between-4 and 2 dBm when transmitting an optical signal at a wavelength within a range of from 1260 nm to 1360 nm and at transmission rates of greater than or equal to 1.6 Tb/s.

In embodiments, the optical fiber 10 exhibits a cable cutoff that varies as a function of position along the length 18 of the optical fiber 10. “Cable cutoff,” for purposes of this disclosure, means the cable cutoff wavelength determined by the 22 m cabled cutoff test described in the EIA-445 Fiber Optic Test Procedures, which are part of the EIA-TIA Fiber Optics Standards, that is, the Electronics Industry Alliance-Telecommunications Industry Association Fiber Optics Standards. Above the cable cutoff, the optical fiber 10 supports propagation of a single mode of electromagnetic radiation. For wavelengths below the cutoff wavelength, multimode or few mode transmission may occur and an additional source of modal dispersion may arise to limit the information carrying capacity of the optical fiber 10. In embodiments, the cable cutoff that the optical fiber 10 exhibits does not exceed 1260 nm along the length 18 of the optical fiber 10. In embodiments, the cable cutoff that the optical fiber 10 exhibits varies entirely within a range of from 1150 nm to 1250 nm along the length 18 of the optical fiber 10. At any given position along the length 18 of the optical fiber 10, the cable cutoff that optical fiber 10 exhibits can be 1150 nm, 1160 nm, 1170 nm, 1180 nm, 1190 nm, 1200 nm, 1210 nm, 1220 nm, 1230 nm, 1240 nm, 1250 nm, or within any range bound by any two of those values (e.g., from 1170 nm to 1240 nm, from 1190 nm to 1230 nm, and so on). By “varies entirely” is meant that the cable cutoff at each position along the length 18 of the optical fiber 10 is within the ranges set forth herein.

In embodiments, the optical fiber 10 exhibits a mode field diameter that varies as a function of the position along the length 18 of the optical fiber 10. Mode field diameter is a measure of the spot size or beam width of light propagating in a single mode fiber. Mode field diameter is a function of the source wavelength, core radius (r_{c}), and refractive index profile. The mode field diameter (MFD) is measured using the Petermann II method 100 and was determined from:

$$MFD = 2 w$$

$$and$$

$${w}^{2} = \frac{{\int }_{0}^{∞} {( f ( r ) )}^{2} dr}{{\int }_{0}^{∞} {( \frac{df ( r )}{dr} )}^{2} rdr}$$

where ƒ(r) is the transverse component of the electric field distribution of the guided light and r is the radial position in the optical fiber 10. Unless otherwise specified, “mode field diameter” or “MFD” refers to the mode field diameter at 1310 nm. In embodiments, the mode field diameter that the optical fiber 10 exhibits varies entirely within a range of from 8.2 μm to 9.5 μm along the length 18 of the optical fiber 10. At any given position along the length 18 of the optical fiber 10, the mode field diameter that optical fiber 10 exhibits can be 8.2 μm, 8.3 μm, 8.4 μm, 8.5 μm, 8.6 μm, 8.7 μm, 8.8 μm, 8.9 μm, 9.0 μm, 9.1 μm, 9.2 μm, 9.3 μm, 9.4 μm, 9.5 μm, or within any range bound by any two of those values (e.g., from 8.4 μm to 9.3 μm, from 8.6 μm to 9.2 μm, and so on). In other embodiments, the mode field diameter that the optical fiber 10 exhibits is less than 8.2 μm or greater than 9.5 μm. By “varies entirely” is meant that the mode field diameter at each position along the length 18 of the optical fiber 10 is within the ranges set forth herein.

In embodiments, the optical fiber 10 exhibits a 15 mm diameter bend loss at 1550 nm of less than or equal to 0.500 dB/turn. “Bend loss” is the difference in the attenuation that the optical fiber 10 exhibits when operating under the prescribed bend condition compared to when operating without the bend. For example, the bend loss that the optical fiber 10 exhibits at a 15 mm bend diameter can be 0.030 dB/turn, 0.040 dB/turn, 0.050 dB/turn, 0.060 dB/turn, 0.070 dB/turn, 0.080 dB/turn, 0.090 dB/turn, 0.100 dB/turn, 0.150 dB/turn, 0.200 dB/turn, 0.250 dB/turn, 0.300 dB/turn, 0.350 dB/turn, 0.400 dB/turn, 0.450 dB/turn, 0.500 dB/turn, or within any range bound by any two of those values (e.g., from 0.030 dB/turn to 0.100 dB/turn, from 0.050 dB/turn to 0.200 dB/turn, and so on).

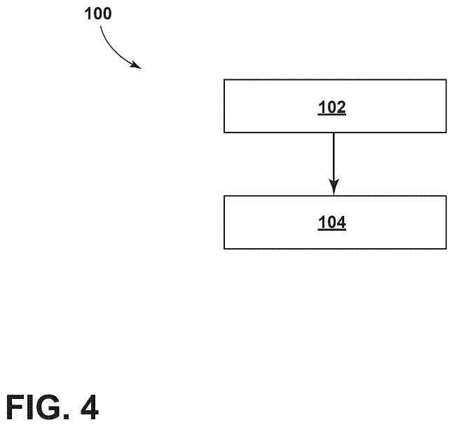

Referring now to FIGS. 4-6, a method 100 of making the optical fiber 10 is herein described. The method 100 includes a drawing step 102 and a tension varying step 104. The drawing step 102 and the tension varying step 104 occur simultaneously. The drawing step 102 includes drawing a length 18 of optical fiber 10 under tension from an optical fiber preform 106.

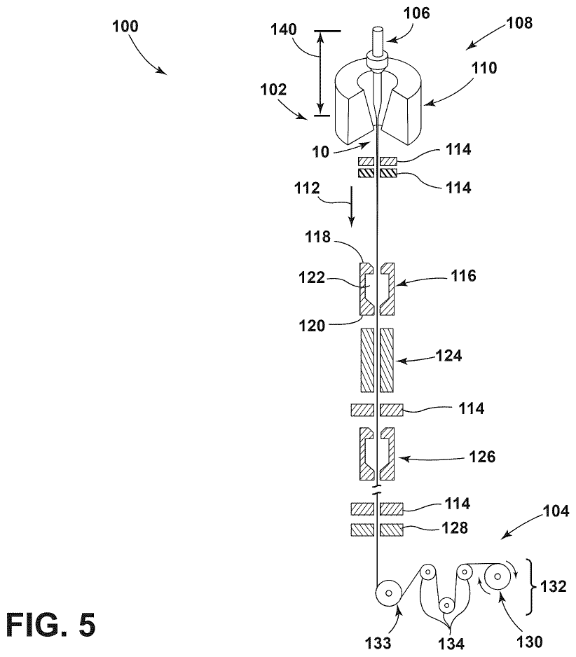

The drawing step 102 can be performed with a drawing system 108 (see FIG. 5). The drawing system 108 may generally include a draw furnace 110 for heating an optical fiber preform 106 such that the optical fiber 10 may be drawn from the optical fiber preform 106. The draw furnace 110 may be oriented along a vertical pathway 112 such that the optical fiber 10 drawn from the optical fiber preform 106 exits the draw furnace 110 along the first vertical pathway 112 in a downward direction. While the drawing step 102 and the tension varying step 104 are occurring, the optical fiber 10 is not subjected to a localized heating or cooling that increases and decreases sequentially and repeatedly in a predetermined manner as a function of time.

After the optical fiber 10 exits the draw furnace 110, the diameter of the optical fiber 10 and a draw tension applied to the optical fiber 10 may be measured with non-contact sensors 114. Thereafter, the optical fiber 10 is passed through a primary coating system 116 where a primary coating is applied to the optical fiber 10. The primary coating system 116 may be configured to apply a UV-curable primary coating to the optical fiber 10 such as a UV-curable acrylate coating. When the primary coating system 116 is configured to apply a UV-curable primary coating to the optical fiber 10, the primary coating system 116 may include a guide die 118 having a first diameter and a sizing die 120 having a second, smaller diameter. Disposed between the guide die 118 and the sizing die 120 is a coating chamber 122. The coating chamber 122 is filled with the UV-curable coating material in liquid form. The optical fiber 10 enters the primary coating system 116 through the guide die 118 and passes through the coating chamber 122 where the UV-curable coating material is applied to the surface of the optical fiber 10. The optical fiber 10 then passes through the sizing die 120 where any excess coating material is removed as the optical fiber 10 exits the primary coating system 116 to achieve a coated optical fiber 10 of a specified diameter corresponding to the diameter of the sizing die 120.

The system may further include an irradiator 124 such that, after the UV-curable coating is applied to the optical fiber 10, the optical fiber 10 with the UV-curable coating passes through the irradiator 124 where the UV-curable coating is cured or hardened. After exiting the irradiator 124, the optical fiber 10 may pass through a non-contact sensor 114 where the diameter of the optical fiber 10 is measured. Thereafter, the optical fiber 10 may be passed through a secondary coating system 126 where a secondary coating is applied to the optical fiber 10 over the primary coating. The secondary coating may be a material having a suitable viscosity prior to curing that is capable of curing quickly to enable processing of the optical fiber 10. The secondary coating system 126 may include an extrusion die for applying the secondary coating to the optical fiber 10. However, it will be understood that the secondary coating system 126 may employ various other dies and/or coating systems suitable for applying a secondary coating to the optical fiber 10 as may be currently known or subsequently developed.

After exiting the secondary coating system 126, the diameter of the coated optical fiber 10 may be measured using a non-contact sensor 114. Thereafter, a non-contact flaw detector 128 may be used to examine the coated optical fiber 10 for damage and/or flaws that may have occurred during the manufacture of the optical fiber 10. After examination by the non-contact sensor 114 and flaw detector 128, the optical fiber 10, now coated with a primary coating or with primary and secondary coatings, is wound onto a fiber storage spool 130 with a fiber take-up system 132. The fiber take-up system 132 utilizes drawing mechanisms 133 and tensioning pulleys 134 to facilitate winding the optical fiber 10 onto a fiber storage spool 130. The tensioning pulleys 134 may provide the necessary tension to the optical fiber 10 as the optical fiber 10 is drawn through the drawing system 108. Accordingly, the fiber take-up system 132 directly contacts optical fiber 10 in order to both wind the optical fiber 10 onto a fiber storage spool 130 as well as to provide the desired tension on the optical fiber 10 as it is drawn through the various stages of the drawing system 108.

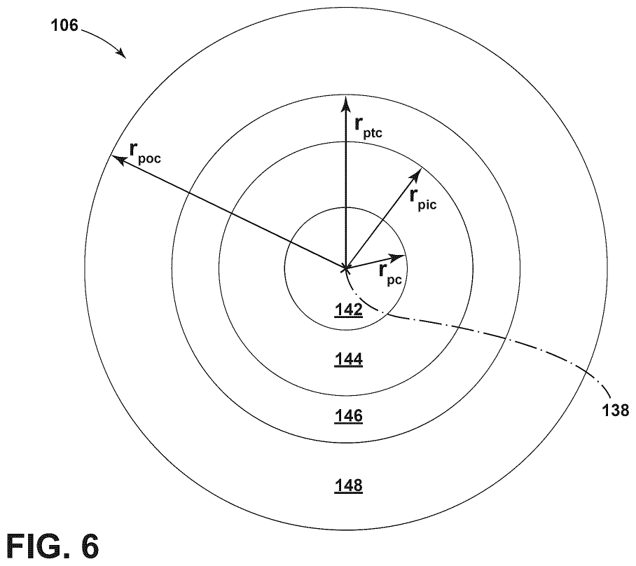

The optical fiber preform 106 (see FIG. 6) is the structural precursor to the optical fiber 10 drawn therefrom. The optical fiber preform 106, like the optical fiber 10, thus includes a preform longitudinal axis 138, a preform length 140, a preform core region 142, a preform inner cladding region 144, a preform trench cladding region 146, and a preform outer cladding region 148. The preform length 140 extends along the preform longitudinal axis 138. The preform core region 142 is centered about the preform longitudinal axis 138. The preform core region 142 extends radially therefrom to a preform core radius (r_{pc}) from the preform longitudinal axis 138. The preform inner cladding region 144 is radially outward of the preform core region 142 and extends from the preform core radius (pc) to a preform inner cladding radius (r_{pic}) from the longitudinal axis 12. The preform trench cladding region 146 is disposed radially outward of the preform inner cladding region 144 from the preform inner cladding radius (r_{pic}) to a preform trench cladding radius (r_{ptc}). Finally, the preform outer cladding region 148 is disposed radially outward of the preform trench cladding region 146 from the preform trench cladding radius (r_{ptc}) to a preform outer cladding radius (r_{poc}). The preform core radius (r_{pc}), the preform inner cladding radius (r_{pic}), the preform trench cladding radius (r_{ptc}), and the preform outer cladding radius (r_{poc}) are all substantially constant as a function of position along the preform length 140. In other words, the optical fiber preform 106 lacks any periodical (or otherwise repeated sequentially increasing and decreasing) variation in any one or more of the preform core radius (r_{pc}), the preform inner cladding radius (r_{pic}), the preform trench cladding radius (r_{ptc}), and the preform outer cladding radius (r_{poc}) along the preform length 140. Instead, each of the preform core radius (r_{pc}), the preform inner cladding radius (pic), the preform trench cladding radius (r_{ptc}), and the preform outer cladding radius (r_{poc}) is substantially constant along the preform length 140, whereby “substantially constant” means that the magnitude of the extent of the variation in each of the preform radii as a function of position along the preform length 140 is less than 5%, or less than 4%, or less than 3%, or less than 2%, or less than 1% of the average of each of the preform radii as a function of position along the preform length 140.

The tension varying step 104 includes increasing and decreasing the tension under which the optical fiber 10 is drawn repeatedly and sequentially in a predetermined manner as a function of time and within a predetermined tension range. In reference to the system described above, the tensioning pulleys 134 can be manipulated to increase or decrease the tension under which the optical fiber 10 is drawn from the optical fiber preform 106, as the case may be, as a function of time. The predetermined tension range is within a range of from 20 grams to 400 grams. For example, the tension at any particular point in time during the tension varying step 104 can be 20 grams, 30 grams, 40 grams, 50 grams, 60 grams, 70 grams, 80 grams, 90 grams, 100 grams, 110 grams, 120 grams, 130 grams, 140 grams, 150 grams, 160 grams, 170 grams, 180 grams, 190 grams, 200 grams, 210 grams, 220 grams, 230 grams, 240 grams, 250 grams, 260 grams, 270 grams, 280 grams, 290 grams, 300 grams, 310 grams, 320 grams, 330 grams, 340 grams, 350 grams, 360 grams, 370 grams, 380 grams, 390 grams, 400 grams, or within any range bound by any two of those values (e.g., from 70 grams to 260 grams, from 210 grams to 390 grams, and so on). The repeated sequence of increasing and then decreasing the tension causes the core refractive index, the inner cladding refractive index, the trench cladding refractive index, and the outer cladding refractive index of the optical fiber 10 to increase and decrease sequentially along the length 18 of the optical fiber 10. Note that the core refractive index, the inner cladding refractive index, the trench cladding refractive index, and the outer cladding refractive index of the optical fiber 10 need not all increase simultaneously or decrease simultaneously. Rather, for example, the core refractive index and the trench cladding refractive index can increase simultaneously, while the inner cladding refractive index and the outer cladding refractive index decrease simultaneously, and vice versa. That in turn causes the zero-dispersion wavelength that the optical fiber 10 exhibits to repeatedly increase and decrease sequentially along the length 18 of the optical fiber 10.

In embodiments, during the tension varying step 104, the tension as a function of time has a substantially sinusoidal profile. In embodiments, during the tension varying step 104, the tension as a function of time has a substantially fixed amplitude. In some instances, the tension varies between a predetermined maximum value and a predetermined minimum value as a function of time.

In embodiments, during the tension varying step 104, the tension as a function of time has a substantially fixed period. In embodiments, the substantially fixed period corresponds to the length 18 of the optical fiber 10 within a range of from 1.0 km to 2.5 km. For example, the length 18 of the optical fiber 10 corresponding to the substantially fixed period can be 1.0 km, 1.1 km, 1.2 km, 1.3 km, 1.4 km, 1.5 km, 1.6 km, 1.7 km, 1.8 km, 1.9 km, 2.0 km, 2.1 km, 2.2 km, 2.3 km, 2.4 km, 2.5 km, or within any range bound by any two of those values (e.g., from 1.7 km to 2.3 km, from 1.9 km to 2.1 km, and so on).

Drawing the optical fiber 10 from the optical fiber preform 106 induces stresses within the optical fiber 10. These stresses include thermal and mechanical stresses due to thermal and viscosity mismatch between different regions of the optical fiber 10. A total stress (σ_{z}) can be calculated by superposition of thermal (σ_{z,th}) and mechanical (σ_{z,me}) stresses, according to the following equation:

$${σ}_{z} = {σ}_{z , th} + {σ}_{z , m e}$$

The mismatch in the coefficients of thermal expansion (CTE) between the different regions of the optical fiber 10 gives rise to thermal stresses.

Considering the optical fiber 10 to be an elastic cylinder, the thermal stresses (σ_{z,th}) can be estimated as:

$${σ}_{z , th} ( z ) = {\int }_{{T}_{r o o m}}^{{T}_{s e t}} \frac{E ( r , T )}{1 - v ( r , T )} [ α ( r , T ) - c ( T ) ] d T$$

where Tₛₑₜ is the setting temperature, Tᵣₒₒₘ is the room temperature, E is the Young's modulus, a is the coefficient of thermal expansion, and v is the Poisson ratio. For an optical fiber 10 of radius R, the parameter c(T) is calculated as:

$$c ( T ) = \frac{2}{{R}^{2}} {\int }_{0}^{R} α ( r , T ) rdr$$

Note that the quantity [α(r,T)−c(T)] represents a variation in the CTE over the optical fiber 10, wherein the parameter c(T) is the average CTE of the optical fiber 10, with R denoting here the outer cladding radius (r_{oc}) of the optical fiber 10.

Different dopants in different regions of the optical fiber 10 can also result in the different regions of the optical fiber 10 having different viscosities. While the CTE α of silica and fluorine doped silica is not very different, their viscosities are very different, resulting in mechanical stresses. The mechanical stress is estimated using the relationship:

$${σ}_{z} = F [ \frac{η ( r )}{{\int }_{0}^{R} 2 π η ( r ) r d r} - \frac{E ( r )}{{\int }_{0}^{R} 2 π E ( r ) r d r} ]$$

where F is the draw tension and η(r) is the viscosity at radial location r. The azimuthal (Θ) and radial (r) components of the stress σ_{θ} and σᵣ are calculated from oz using the following relationships:

$${σ}_{r} = \frac{1}{{r}^{2}} {\int }_{0}^{r} {σ}_{z} rdr$$

$${σ}_{r} + {σ}_{θ} = {σ}_{z}$$

Because of the stresses that are induced in the optical fiber 10 during the drawing process, the atomic distance as well as the electron shells of the atoms that make up the different regions of the optical fiber 10 can be influenced. These cause a change Δn in refractive index of the glass, which in cylindrical coordinates (r,Θ,z) is given as:

$$Δ {n}_{r} = {n}_{r} - n = - {B}_{2} {σ}_{r} - {B}_{1} ( {σ}_{θ} + {σ}_{z} )$$

$$Δ {n}_{θ} = {n}_{θ} - n = - {B}_{2} {σ}_{θ} - {B}_{1} ( {σ}_{r} + {σ}_{z} )$$

$$Δ {n}_{z} = {n}_{z} - n = - {B}_{2} {σ}_{z} - {B}_{1} ( {σ}_{θ} + {σ}_{r} )$$

where n is the refractive index of unstressed glass; nᵣ, n_{θ}, and n_{z} are the refractive indices in the radial, azimuthal, and axial directions respectively, of the stressed glass; Δnᵣ, Δn_{θ}, and Δn_{z} are the refractive index changes induced by tension in the radial, azimuthal and axial direction respectively; and B₁ and B₂ are the stress-optical coefficients.

The equations above provide an explicit connection between the draw tension F and the optical fiber 10 refractive index profile n(r,Θ,z) via the stress optic coefficients B₁ and B₂. Since the optical fiber 10 refractive index profile n(r,Θ,z) defines or is defined by the optical properties of the drawn optical fiber 10, the above equations provide guidance for adjusting the draw tension F to adjust the optical fiber 10 refractive index profile. The draw tension F can be adjusted either based on measurements of one or more optical properties of a reference optical fiber 10 or based on measurements of the optical fiber preform 106 refractive index profile.

The optical fiber 10 and the method 100 of the present disclosure address issues arising from Kerr-induced nonlinear effects, including four-wave mixing, mentioned in the Background, among others, in a variety of ways. Among them, the zero-dispersion wavelength that the optical fiber 10 exhibits varies along the length 18 of the optical fiber 10, rising and falling repeatedly and sequentially. The zero-dispersion wavelength varies because the core refractive index, the inner cladding refractive index, the trench cladding refractive index, and the outer cladding refractive index all vary along the length 18 of the optical fiber 10. Unlike other attempts to manipulate the refractive indices, the core composition, the inner cladding composition, the trench cladding composition, and the outer cladding composition are all substantially constant as a function of position along the length 18 of the optical fiber 10. Likewise, compositions of the preform core region 142, the preform inner cladding region 144, the preform trench cladding region 146, and the preform outer cladding region 146 are all substantially constant as a function of position along the length 18 of the optical fiber preform 106. The optical fiber preform 106 is thus easier to manufacture and there is no need to carefully control dopant composition along the preform length 140 of the optical fiber preform 106. Further, unlike other attempts to manipulate the refractive indices, during performance of the method 100 of the present disclosure, the optical fiber 10 is not subjected to a repeated sequence of localized heating or cooling. Thus, the method 100 is easier to perform. Similarly, the preform core radius (r_{pc}), the preform inner cladding radius (r_{pic}), the preform trench cladding radius (r_{ptc}), and the preform outer cladding radius (r_{poc}) are all substantially constant along the preform length 140 of the optical fiber preform 106. Prior attempts manufactured the preform so that one or more of those radii repeatedly increased and decreased in sequence. The optical fiber preform 106 of the present disclosure is thus easier to make and easier to draw the optical fiber 10 therefrom. The method 100 of the present disclosure achieves variability in the indices of refraction by changing the tension applied during the draw so as to repeatedly increase and decrease sequentially the tension as a function of time. That translates to the repeated variability of the refractive indices of the various regions of the optical fiber 10. In turn, that causes the repeated increase and decrease sequentially in the zero-dispersion wavelength that the optical fiber 10 exhibits, which reduces Kerr-induced nonlinear effects overall. Finally, the present disclosure discloses how the optical fiber 10 can exhibit extremely low BER (indicative of low FWM) through control of the amplitude and period of the variation of the zero-dispersion wavelength along the length 18 of the optical fiber 10. Controlling the tension during the method 100 achieves the desired amplitude and period of the variation of the zero-dispersion wavelength.

### EXAMPLES

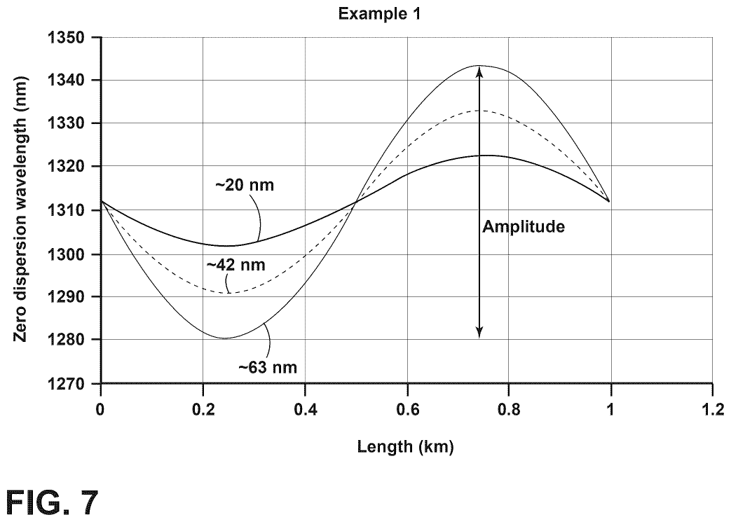

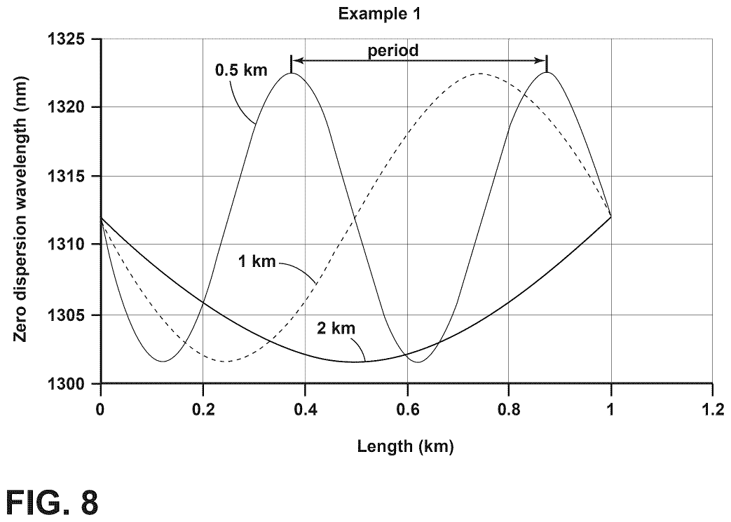

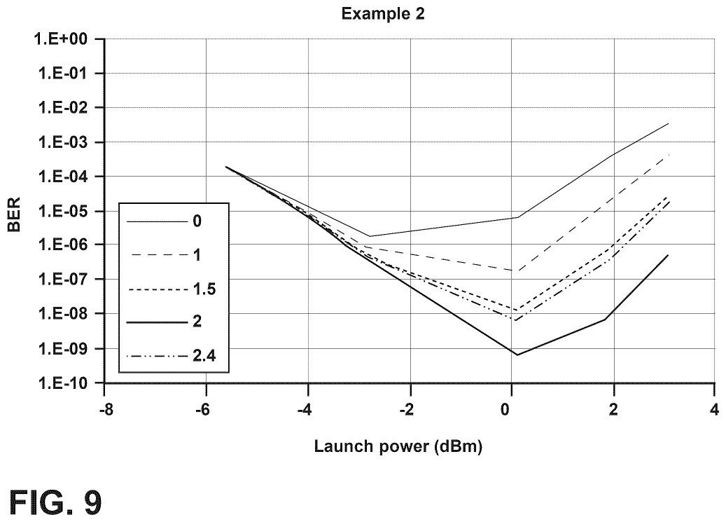

Example 1—The graphs reproduced at FIGS. 7 and 8 illustrate that the zero-dispersion wavelength that the optical fiber exhibits can be made to vary in a sinusoidal manner along the length of the optical fiber. In addition, the graph of FIG. 7 illustrates that the modulation amplitude of the sinusoidal variation can be engineered as desired while maintaining a constant modulation period of 1 km. Similarly, the graph of FIG. 8 illustrates that the modulation period of the sinusoidal variation can be engineered as desired while maintaining a constant modulation amplitude of about 21 nm. For the computer modeling of this example and the Examples 2 and 3 that follow, no specific composition for the optical fiber was assumed.
Example 2—For Example 2, computer modeling was performed to determine BER as a function of launch power for an optical fiber with a zero-dispersion wavelength that varied in a sinusoidal manner along the length of the optical fiber and as a function of the modulation amplitude of the sinusoidal variation with a fixed modulation period of 2 km. The results are reproduced graphically at FIG. 9. The numerical identifiers for the modulation amplitude (0, 1, 1.5, 2, and 2.4) refer to relative degrees of modulation amplitude, where 0 means no modulation amplitude variation (e.g., zero-dispersion wavelength was constant along the length), 2 means twice the modulation amplitude of 1, and so on. The graph illustrates that BER reduces substantially when sinusoidal variation in zero-dispersion wavelength is introduced (e.g., 0 modulation amplitude, no variation, exhibited the highest BER). Further, the graph illustrates that modulation amplitude of the sinusoidal variation in zero-dispersion wavelength can be optimized (here, modulation amplitude level 2) to generate a minimum BER. The BER decreased sequentially for relative modulation amplitudes of 0, 1, 1.5, and 2, before increasing again for the relative modulation amplitude of 2.4. More particularly, the minimum BER with no sinusoidal variation (modulation amplitude of 0) at a launch power of 0 dBm would be just less than 1×10⁻⁵. However, with the relative modulation amplitude of 2, the BER at a launch power of 0 dBm would be just less than 1×10⁻⁹.

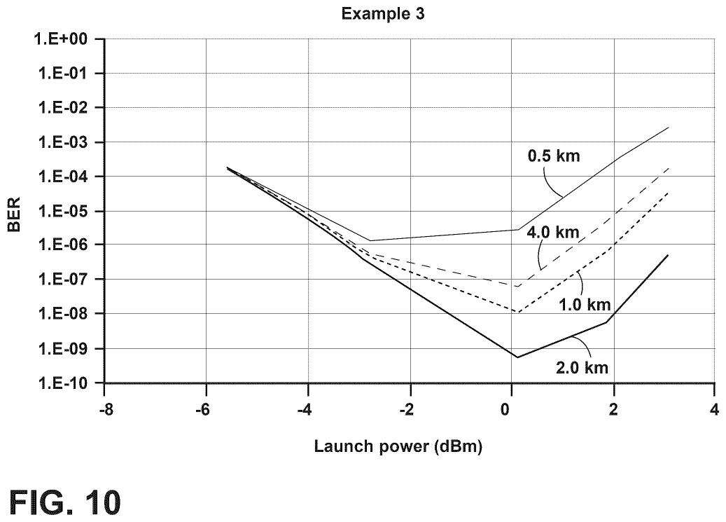

The computer model assumed a Continuous Wave Wavelength Division Multiplexing (CW-WDM) link with 64 multiplexed wavelengths, each operating at 32 Gbit/s, to achieve an aggregate transmission rate of 2.0 Tbit/s. The wavelength assumed for the graph of FIG. 9 was 1297.25 nm. The wavelengths for the modeling ranged from 1291.1 nm to 1309.14 nm. The same holds true for Example 3 that follows.
Example 3—For Example 3, the same computer modeling was again performed to determine BER as a function of launch power for an optical fiber with a zero-dispersion wavelength that varied in a sinusoidal manner along the length of the optical fiber and as a function of the modulation period of the sinusoidal variation with a fixed modulation amplitude corresponding to level 2 of Example 2. The results are reproduced graphically at FIG. 10. The graph illustrates that the modulation period of the sinusoidal variation in zero-dispersion wavelength can be optimized (here, modulation period of 2.0 km) to generate a minimum BER. The BER decreased sequentially for the periods of 0.5 km, 1.0 km, and 2.0 km, before increasing again for the modulation period of 4.0 km. More particularly, the BER with a sinusoidal variation modulation period of 0.5 km at a launch power of 0 dBm would be between 1×10⁻⁵ and 1×10⁻⁶. However, with the period of 2.0 km, the BER at a launch power of 0 dBm would be just less than 1×10⁻⁹.
Example 4—For Example 4, computer modeling was performed to determine axial stress as a function of radius from the longitudinal axis of a single mode bend-insensitive optical fiber and as a function of tension during a drawing step. The model assumed that the core region had a core composition of silica doped with 6.7 wt % GeO₂ (corresponding to core refractive index of 0.378% Δ), an inner cladding region having an inner cladding composition of silica doped with 1200 ppm chlorine (corresponding to an inner cladding refractive index of 0.1% Δ), a trench cladding region having a trench cladding composition of silica doped with 0.77 wt % fluorine (corresponding to a trench cladding refractive index of −0.206% Δ), and an outer cladding region having an outer cladding composition of silica doped with 1200 ppm chlorine (corresponding to an outer cladding refractive index of 0.1% Δ). The tensions during the drawing step modeled were 30 g, 50 g, 100 g, 150 g, and 200 g.

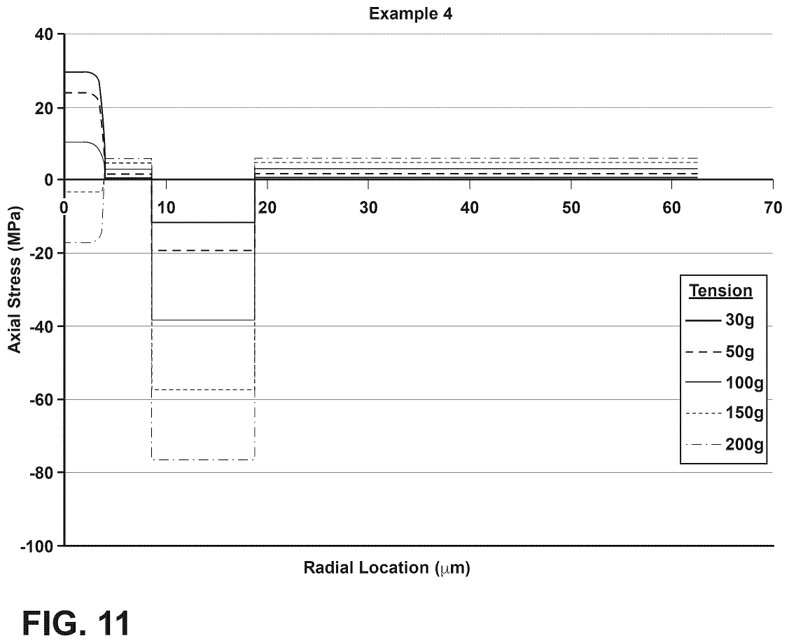

The results are reproduced graphically at FIG. 11. The graph reveals that as the tension increases, the axial stresses at the core region and the trench cladding region decreased while the axial stresses at the inner cladding region and the outer cladding region increased.

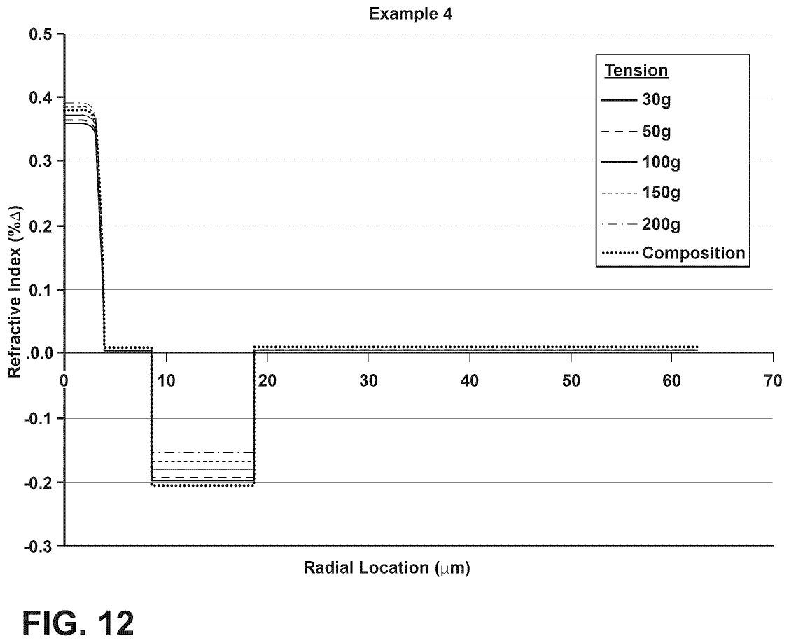

From the axial stresses, the relative refractive indices at the various regions could be calculated for the various tensions during the drawing step examined. The results are reproduced graphically at FIG. 12 and numerically at Table 1 below. The relative refractive index values were as measured at a wavelength of 630 nm. However, the profile in terms of % Δ with respect to silica index would be similar at 1550 nm, because the change in index with wavelength is similar for different doped regions. Thus, it is acceptable to consider the % Δ is at 1550 nm. Table 1 below further includes calculated mode field diameter (MFD), zero-dispersion wavelengths, trench volume, cable cutoff values, and bend losses for various diameter turns.

TABLE 1

| Optical | | 30 g | 50 g | 100 g | 150 g | 200 g |
|---|---|---|---|---|---|---|
| Parameter | Composition | tension | tension | tension | tension | tension |
| Δ_{c-max} (%) | 0.378 | 0.358 | 0.362 | 0.371 | 0.38 | 0.389 |
| r_{c} (μm) | 4 | 4 | 4 | 4 | 4 | 4 |
| Δ_{ic} (%) | 0.01 | 0.00948 | 0.00907 | 0.00804 | 0.00702 | 0.006 |
| r_{ic} (μm) | 8.625 | 8.625 | 8.625 | 8.625 | 8.625 | 8.625 |
| Δ_{tc} (%) | −0.206 | −0.198 | −0.193 | −0.18 | −0.167 | −0.154 |
| r_{tc} (μm) | 18.75 | 18.75 | 18.75 | 18.75 | 18.75 | 18.75 |
| Δ_{oc} (%) | 0.01 | 0.00948 | 0.00907 | 0.00804 | 0.00702 | 0.006 |
| r_{oc} (μm) | 62.5 | 62.5 | 62.5 | 62.5 | 62.5 | 62.5 |
| MFD at | 8.46 | 8.61 | 8.58 | 8.51 | 8.43 | 8.36 |
| 1310 nm | | | | | | |
| (μm) | | | | | | |
| Zero- | 1314 | 1302 | 1302 | 1303 | 1304 | 1304 |
| Dispersion | | | | | | |
| Wavelength | | | | | | |
| (nm) | | | | | | |
| Trench | 59.75 | 57.45 | 55.92 | 52.08 | 48.24 | 44.4 |
| Volume | | | | | | |
| (%Δ-μm²) | | | | | | |
| Cable | 1213 | 1175 | 1178 | 1184 | 1190 | 1190 |
| Cutoff (nm) | | | | | | |
| 15 mm | 0.034 | 0.074 | 0.072 | 0.069 | 0.068 | 0.067 |
| diameter | | | | | | |
| bend loss | | | | | | |
| (dB/turn) | | | | | | |
| 20 mm | 0.008 | 0.017 | 0.017 | 0.016 | 0.015 | 0.014 |
| diameter | | | | | | |
| bend loss | | | | | | |
| (dB/turn) | | | | | | |
| 30 mm | 0.001 | 0.0026 | 0.0023 | 0.0017 | 0.0013 | 0.001 |
| diameter | | | | | | |
| bend loss | | | | | | |
| (dB/turn) | | | | | | |

Table 1 reveals that the core refractive index and the trench cladding refractive index increase with increasing tension, while the inner cladding refractive index and the outer cladding refractive index decrease with increasing tension. Further, the zero-dispersion wavelength increases with increasing tension.

Because changing the tension during the drawing step can alter the refractive index profile, the tension can be varied as a function of time (and thus as a function of length along the optical fiber). The variance in the tension causes variance in the refractive index profile and thus variance in the zero-dispersion wavelength as a function of position along the length along the optical fiber.

It will be apparent to those skilled in the art that various modifications and variations can be made without departing from the spirit or scope of the claims.

What is claimed is:

1. An optical fiber comprising:
a longitudinal axis;
a length extending along the longitudinal axis;
a core region centered about the longitudinal axis to a core radius (r_{c}) from the longitudinal axis, the core comprising a core composition and exhibiting a core refractive index;
an inner cladding region disposed radially outward of the core region from the core radius (r_{c}) to an inner cladding radius (r_{ic}) from the longitudinal axis, the inner cladding region comprising an inner cladding composition and exhibiting an inner cladding refractive index that is less than the core refractive index;
a trench cladding region disposed radially outward of the inner cladding region from the inner cladding radius (r_{ic}) to a trench cladding radius (r_{tc}), the trench cladding region comprising a trench cladding composition and exhibiting a trench cladding refractive index that is less than the inner cladding refractive index; and
an outer cladding region disposed radially outward of the trench cladding region from the trench cladding radius (r_{tc}) to an outer cladding radius (r_{oc}), the outer cladding region comprising an outer cladding composition and exhibiting an outer cladding refractive index that is greater than the trench cladding refractive index,
wherein, the core radius (r_{c}), the inner cladding radius (r_{ic}), the trench cladding radius (r_{tc}), and the outer cladding radius (r_{oc}) are all substantially constant as a function of position along the length of the optical fiber,
wherein, the core composition, the inner cladding composition, the trench cladding composition, and the outer cladding composition are all substantially constant as a function of position along the length of the optical fiber,
wherein, the core refractive index, the inner cladding refractive index, the trench cladding refractive index, and the outer cladding refractive index all vary as a function of position along the length of the optical fiber, and
wherein, the optical fiber has a non-uniform distribution of zero-dispersion wavelength along the length of the optical fiber, with the zero-dispersion wavelength repeatedly rising and falling in sequence along the length of the optical fiber, and comprising an average zero-dispersion wavelength within a range of from 1300 nm to 1324 nm and a peak-to-valley variation greater than or equal to 5 nm.

2. The optical fiber of claim 1, wherein
the trench cladding region further comprises a trench volume that varies as a function of the position along the length of the optical fiber; and
the trench volume varies entirely within a range of from 20%-μm² to 65%-μm².

3. The optical fiber of claim 1, wherein
the non-uniform distribution of zero-dispersion wavelength comprises a distribution of zero-dispersion wavelength that varies periodically along the length of the optical fiber, the periodically varying distribution comprising a modulation amplitude and a modulation period.

4. The optical fiber of claim 3, wherein
the modulation amplitude of the zero-dispersion wavelength is within a range of from 5.0 nm to 18.0 nm.

5. The optical fiber of claim 3, wherein
the modulation period of the zero-dispersion wavelength is within a range of from 1.0 km to 2.5 km.

6. The optical fiber of claim 3, wherein
the periodically varying distribution is sinusoidal.

7. The optical fiber of claim 1, wherein
the optical fiber exhibits a bit error rate (BER) of less than 5×10⁻⁶/km for a launch power within a range of from −4 to 2 dBm when transmitting an optical signal at a wavelength within a range of from 1260 nm and 1360 nm and at a transmission rate of greater than or equal to 1.6 Tb/s.

8. The optical fiber of claim 7, wherein
the BER that the optical fiber exhibits is less than 5×10⁻⁷/km for a launch power within a range of from −4 to 2 dBm when transmitting an optical signal at a wavelength within a range of from 1260 nm and 1360 nm and at a transmission rate of greater than or equal to 1.6 Tb/s.

9. The optical fiber of claim 8, wherein
the BER that the optical fiber exhibits is less than 5×10⁻⁸/km for a launch power within a range of from −4 to 2 dBm when transmitting an optical signal at a wavelength within a range of from 1260 nm and 1360 nm and at a transmission rate of greater than or equal to 1.6 Tb/s.

10. The optical fiber of claim 1, wherein
the optical fiber exhibits a cable cutoff that repeatedly increases and decreases in sequence along the length of the optical fiber.

11. The optical fiber of claim 10, wherein
the cable cutoff that the optical fiber exhibits does not exceed 1260 nm along the length of the optical fiber.

12. The optical fiber of claim 10, wherein
the cable cutoff that the optical fiber exhibits varies entirely within a range of from 1150 nm to 1250 nm along the length of the optical fiber.

13. The optical fiber of claim 1, wherein
the optical fiber exhibits a mode field diameter that varies as a function of the position along the length of the optical fiber.

14. The optical fiber of claim 13, wherein
the mode field diameter that the optical fiber exhibits varies entirely within a range of from 8.2 μm to 9.5 μm along the length of the optical fiber.

15. The optical fiber of claim 1, wherein
the optical fiber exhibits a 15 mm diameter bend loss at 1550 nm of less than or equal to 0.5 dB/turn.

16. A method of making optical fiber comprising:
a drawing step comprising drawing a length of optical fiber under tension from an optical fiber preform; and
a tension varying step comprising repeatedly and sequentially increasing and decreasing the tension under which the optical fiber is drawn in a predetermined manner as a function of time and within a predetermined tension range, wherein
while the drawing step and the tension varying step are occurring, the optical fiber is not subjected to localized heating or cooling that varies in a predetermined manner as a function of time,
the predetermined tension range is from 20 grams to 400 grams,
the optical fiber preform comprises:
a preform longitudinal axis,
a preform length extending along the preform longitudinal axis,
a preform core region centered about the preform longitudinal axis and extending therefrom to a preform core radius from the preform longitudinal axis,
a preform inner cladding region disposed radially outward of the preform core region from the preform core radius to a preform inner cladding radius from the preform inner cladding longitudinal axis,
a preform trench cladding region disposed radially outward of the preform inner cladding region from the preform inner cladding radius to a preform trench cladding radius,
a preform outer cladding region disposed radially outward of the preform trench cladding region from the preform trench cladding radius to a preform outer cladding radius, and
the preform core radius, the preform inner cladding radius, the preform trench cladding radius, and the preform outer cladding radius are all substantially constant as a function of position along the preform length.

17. The method of claim 16, wherein
during the tension varying step, the tension as a function of time has a substantially fixed amplitude.

18. The method of claim 16, wherein
during the tension varying step, the tension as a function of time has a substantially fixed period.

19. The method of claim 18, wherein
the substantially fixed period corresponds to the length of the optical fiber within a range of from 1.5 km to 2.5 km.

20. The method of claim 16, wherein
during the tension varying step, the tension as a function of time has a substantially sinusoidal profile.
